(19) United States
(12) Patent Application Publication
(10) Pub. No.: US 2011/0115880 A1
(43) Pub. Date: May 19, 2011

(54) IMAGE DISPLAY APPARATUS AND OPERATING METHOD THEREOF

(75) Inventors: Kyung Hee YOO, Seoul (KR); Sang Jun Koo, Seoul (KR); Sae Hun Jang, Seoul (KR); Uni Young Kim, Seoul (KR); Hyung Nam Lee, Seoul (KR)

(73) Assignee: LG ELECTRONICS INC., Seoul (KR)

(21) Appl. No.: 12/905,821

(22) Filed: Oct. 15, 2010

(30) Foreign Application Priority Data
Nov. 16, 2009 (KR) 10-2009-0110397

(51) Int. Cl. H04N 13/00

(52) U.S. Cl. 348/42; 348/E13.001

(57) ABSTRACT

An image display apparatus and an operating method thereof where the image display apparatus may display a three-dimensional (3D) object and may process an image signal such that the depth of a 3D object can vary according to the priority level of the 3D object. Thus, a user may view a 3D object having a depth from the image display apparatus that varies according to the 3D object's priority level.

### CROSS-REFERENCE TO RELATED APPLICATION

This application claims the priority benefit of Korean Patent Application No. 10-2009-0110397, filed Nov. 16, 2009, respectively, in the Korean Intellectual Property Office, the disclosure of which is incorporated herein by reference.

### BACKGROUND OF THE INVENTION

1. Field of the Invention

The present invention relates to an image display apparatus and an operating method thereof, and more particularly, to an image display apparatus, which is capable of displaying a screen to which a stereoscopic effect is applied and thus providing a sense of three-dimensionality, and an operating method of the image display apparatus.

2. Description of the Related Art

Image display apparatuses display various video data viewable to users. In addition, image display apparatuses allow users to select some broadcast video signals from all the broadcast video signals transmitted by a broadcasting station, and then display the selected broadcast video signals. The broadcasting industry is in the process of converting from analog to digital broadcasting worldwide.

Digital broadcasting is characterized by transmitting digital video and audio signals. Digital broadcasting can offer various advantages over analog broadcasting such as robustness against noise, no or little data loss, the ease of error correction and the provision of high-resolution, high-definition screens. The commencement of digital broadcasting has enabled the provision of various interactive services.

In the meantime, various research has been conducted on stereoscopic images. As a result, stereoscopy is nowadays being applied to various industrial fields including the field of digital broadcasting. For this, the development of techniques for effectively transmitting stereoscopic images for digital broadcasting purposes and devices capable of reproducing such stereoscopic images is now under way.

### SUMMARY OF THE INVENTION

The present invention provides an image display apparatus capable of displaying a screen to which a stereoscopic effect is applied so as to provide a sense of three-dimensionality and an operating method of the image display apparatus.

The present invention also provides a user interface (UI) that can be applied to an image display apparatus capable of displaying a screen to which a stereoscopic effect is applied and can thus improve user convenience.

According to an aspect of the present invention, there is provided an operating method of an image display apparatus capable of displaying a three-dimensional (3D) object, the operating method including processing an image signal so as to determine a depth of a 3D object; and displaying the 3D object based on the processed image signal, wherein the depth of the 3D object corresponds to a priority level of the 3D object.

According to another aspect of the present invention, there is provided an image display apparatus capable of displaying a 3D object, the image display apparatus including a control unit which processes an image signal so as to determine a depth of a 3D object; and a display unit which displays the 3D object based on the processed image signal, wherein the depth of the 3D object corresponds to a priority level of the 3D object.

### BRIEF DESCRIPTION OF THE DRAWINGS

The above and other features and advantages of the present invention will become more apparent by describing in detail various embodiments thereof with reference to the attached drawings in which:

FIG. 1 illustrates a block diagram of an image display apparatus according to an exemplary embodiment of the present invention;

FIG. 2 illustrates various types of external devices that can be connected to the image display apparatus shown in FIG. 1;

FIGS. 3(a) and 3(b) illustrate block diagrams of a control unit shown in FIG. 1;

FIGS. 4(a) through 4(g) illustrate how a formatter shown in FIG. 3 separates a two-dimensional (2D) image signal and a three-dimensional (3D) image signal;

FIGS. 5(a) through 5(e) illustrate various 3D image formats provided by the formatter shown in FIG. 3;

FIGS. 6(a) through 6(c) illustrate how the formatter shown in FIG. 3 scales a 3D image;

FIGS. 7A through 7C illustrate various images that can be displayed by the image display apparatus shown in FIG. 1; and

FIGS. 8 through 15B illustrate diagrams for explaining the operation of the image display apparatus shown in FIG. 1.

### DETAILED DESCRIPTION OF THE INVENTION

The present invention will hereinafter be described in detail with reference to the accompanying drawings in which exemplary embodiments of the invention are shown. In this disclosure, the terms ‘module’ and ‘unit’ can be used interchangeably.

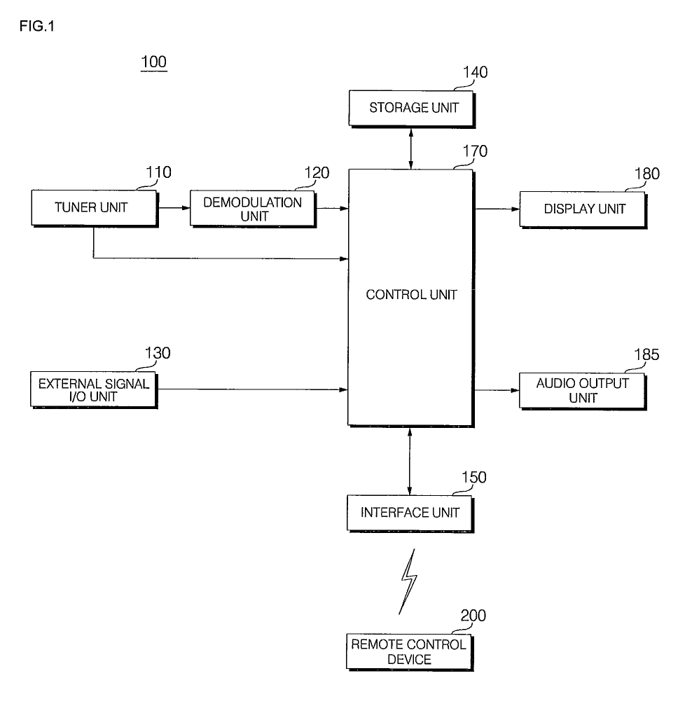

FIG. 1 illustrates a block diagram of an image display apparatus 100 according to an exemplary embodiment of the present invention. Referring to FIG. 1, the image display apparatus 100 may include a tuner unit 110, a demodulation unit 120, an external signal input/output (I/O) unit 130, a storage unit 140, an interface 150, a sensing unit (not shown), a control unit 170, a display unit 180, and an audio output unit 185.

The tuner unit 110 may select a radio frequency (RF) broadcast signal corresponding to a channel selected by a user or an RF broadcast signal corresponding to a previously-stored channel from a plurality of RF broadcast signals received via an antenna and may convert the selected RF broadcast signal into an intermediate-frequency (IF) signal or a baseband audio/video (A/V) signal. More specifically, if the selected RF broadcast signal is a digital broadcast signal, the tuner unit 110 may convert the selected RF broadcast signal into a digital IF signal (DIF.) On the other hand, if the selected RF broadcast signal is an analog broadcast signal, the tuner unit 110 may convert the selected RF broadcast signal into an analog baseband A/V signal (e.g., a composite video blanking sync/ sound intermediate frequency (CVBS/SIF) signal.) That is, the tuner unit 110 can process both digital broadcast signals and analog broadcast signals. The analog baseband A/V signal CVBS/SIF may be directly transmitted to the control unit 170.

The tuner unit 110 may be able to receive RF broadcast signals from an Advanced Television Systems Committee (ATSC) single-carrier system or from a Digital Video Broadcasting (DVB) multi-carrier system.

The tuner unit 110 may sequentially select a number of RF broadcast signals respectively corresponding to a number of channels previously added to the image display apparatus 100 by a channel-add function from a plurality of RF signals received through the antenna, and may convert the selected RF broadcast signals into IF signals or baseband A/V signals in order to display a thumbnail list including a plurality of thumbnail images on the display unit 180. Thus, the tuner unit 110 can receive RF broadcast signals sequentially or periodically not only from the selected channel but also from a previously-stored channel.

The demodulation unit 120 may receive the digital IF signal DIF from the tuner unit 110 and may demodulate the digital IF signal (DIF.)

More specifically, if the digital IF signal (DIF) is, for example, an ATSC signal, the demodulation unit 120 may perform 8-Vestigal SideBand (VSB) demodulation on the digital IF signal DIF. The demodulation unit 120 may perform channel decoding. For this, the demodulation unit 120 may include a Trellis decoder, a de-interleaves and a Reed-Solomon decoder and may thus be able to perform Trellis decoding, de-interleaving and Reed-Solomon decoding.

On the other hand, if the digital IF signal DIF is, for example, a DVB signal, the demodulation unit 120 may perform coded orthogonal frequency division modulation (COFDMA) demodulation on the digital IF signal (DIF.) The demodulation unit 120 may perform channel decoding. For this, the demodulation unit 120 may include a convolution decoder, a de-interleaves, and a Reed-Solomon decoder and may thus be able to perform convolution decoding, de-interleaving and Reed-Solomon decoding.

The demodulation unit 120 may perform demodulation and channel decoding on the digital IF signal DIF, thereby providing a stream signal TS into which a video signal, an audio signal and/or a data signal are multiplexed. The stream signal TS may be an MPEG-2 transport stream into which an MPEG-2 video signal and a Dolby AC-3 audio signal are multiplexed. An MPEG-2 transport stream may include a 4-byte header and a 184-byte payload.

The demodulation unit 120 may include an ATSC demodulator for demodulating an ATSC signal and a DVB demodulator for demodulating a DVB signal.

The stream signal TS may be transmitted to the control unit 170. The control unit 170 may perform demultiplexing and signal processing on the stream signal TS, thereby outputting video data and audio data to the display unit 180 and the audio output unit 185, respectively.

The external signal I/O unit 130 may connect the image display apparatus 100 to an external device. For this, the external signal I/O unit 130 may include an A/V I/O module or a wireless communication module.

The external signal I/O unit 130 may be connected to an external device such as a digital versatile disc (DVD), a Blu-ray disc, a gaming device, a camera, a camcorder, or a computer (e.g., a laptop computer) either non-wirelessly or wirelessly. Then, the external signal I/O unit 130 may receive various video, audio and data signals from the external device and may transmit the received signals to the control unit 170. In addition, the external signal I/O unit 130 may output various video, audio and data signals processed by the control unit 170 to the external device.

In order to transmit A/V signals from an external device to the image display apparatus 100, the A/V I/O module of the external signal I/O unit 130 may include an Ethernet port, a universal serial bus (USB) port, a composite video blanking sync (CVBS) port, a component port, a super-video (S-video) (analog) port, a digital visual interface (DVI) port, a high-definition multimedia interface (HDMI) port, a red-green-blue (RGB) port, and a D-sub port.

The wireless communication module of the external signal I/O unit 130 may wirelessly access the internet, i.e., may allow the image display apparatus 100 to access a wireless internet connection. For this, the wireless communication module may use various communication standards such as a wireless local area network (WLAN) (i.e., Wi-Fi), Wireless broadband (Wibro), World Interoperability for Microwave Access (Wimax), or High Speed Downlink Packet Access (HSDPA).

In addition, the wireless communication module may perform short-range wireless communication with other electronic devices. The image display apparatus 100 may be networked with other electronic devices using various communication standards such as Bluetooth, radio-frequency identification (RFID), Infrared Data Association (IrDA), Ultra Wideband (UWB), or ZigBee.

The external signal I/O unit 130 may be connected to various set-top boxes through at least one of an Ethernet port, a USB port, a CVBS port, a component port, an S-video port, a DVI port, a HDMI port, a RGB port, a D-sub port, an IEEE-1394 port, a S/PDIF port, and a liquidHD port and may thus receive data from or transmit data to the various set-top boxes. For example, when connected to an Internet Protocol Television (IPTV) set-top box, the external signal I/O unit 130 may transmit video, audio and data signals processed by the IPTV set-top box to the control unit 170 and may transmit various signals provided the control unit 170 to the IPTV set-top box. In addition, video, audio and data signals processed by the IPTV set-top box may be processed by the channel-browsing processor 170 and then the control unit 170.

The term ‘IPTV’, as used herein, may cover a broad range of services such as ADSL-TV, VDSL-TV, FTTH-TV, TV over DSL, Video over DSL, TV over IP (TVIP), Broadband TV (BTV), and Internet TV and full-browsing TV, which are capable of providing Internet-access services.

The external signal I/O unit 130 may be connected to a communication network so as to be provided with a video or voice call service. Examples of the communication network include a broadcast communication network (such as a local area network (LAN)), a public switched telephone network (PTSN), and a mobile communication network.

The storage unit 140 may store various programs necessary for the control unit 170 to process and control signals. The storage unit 140 may also store video, audio and/or data signals processed by the control unit 170.

The storage unit 140 may temporarily store video, audio and/or data signals received by the external signal I/O unit 130. In addition, the storage unit 140 may store information regarding a broadcast channel with the aid of a channel add function.

The storage unit 140 may include at least one of a flash memory-type storage medium, a hard disc-type storage medium, a multimedia card micro-type storage medium, a card-type memory (such as a secure digital (SD) or extreme digital (XD) memory), a random access memory (RAM), and a read-only memory (ROM) (such as an electrically erasable programmable ROM (EEPROM)). The image display apparatus 100 may play various files (such as a moving image file, a still image file, a music file or a document file) in the storage unit 140 for a user.

The storage unit 140 is illustrated in FIG. 1 as being separate from the control unit 170, but the present invention is not restricted to this. That is, the storage unit 140 may be included in the control unit 170.

The interface 150 may transmit a signal input thereto by a user to the control unit 170 or transmit a signal provided by the control unit 170 to a user. For example, the interface 150 may receive various user input signals such as a power-on/off signal, a channel-selection signal, and a channel-setting signal from a remote control device 200 or may transmit a signal provided by the control unit 170 to the remote control device 200. The sensing unit may allow a user to input various user commands to the image display apparatus 100 without the need to use the remote control device 200. The structure of the sensing unit will be described later in further detail.

The control unit 170 may demultiplex an input stream provided thereto via the tuner unit 110 and the demodulation unit 120 or via the external signal I/O unit 130 a number of signals and may process the signals obtained by the demultiplexing in order to output AN data. The control unit 170 may control the general operation of the image display apparatus 100.

The control unit 170 may control the image display apparatus 100 in accordance with a user command input thereto via the interface unit 150 or the sensing unit or a program present in the image display apparatus 100.

The control unit 170 may include a demultiplexer (not shown), a video processor (not shown) and an audio processor (not shown). The control unit 170 may control the tuner unit 110 to tune to select an RF broadcast program corresponding to a channel selected by a user or a previously-stored channel.

The control unit 170 may include a demultiplexer (not shown), a video processor (not shown), an audio processor (not shown), and a user input processor (not shown).

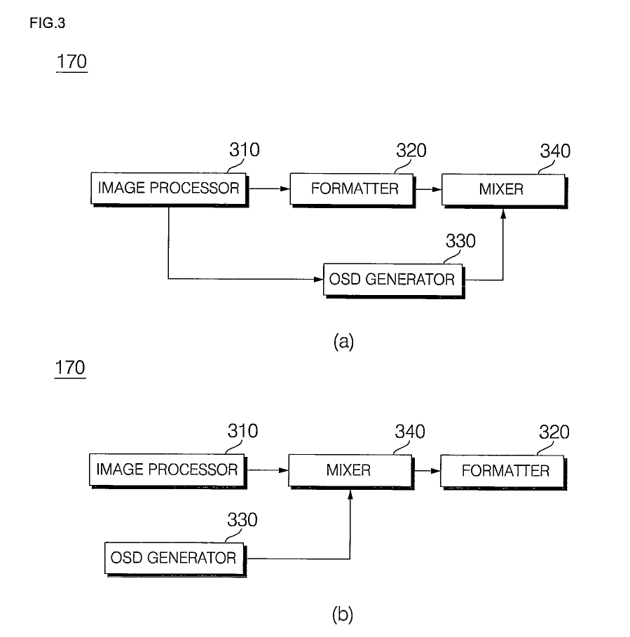

The control unit 170 may demultiplex an input stream signal, e.g., an MPEG-2 TS signal, into a video signal, an audio signal and a data signal. The input stream signal may be a stream signal output by the tuner unit 110, the demodulation unit 120 or the external signal I/O unit 130. The control unit 170 may process the video signal. More specifically, the control unit 170 may decode the video signal using different codecs according to whether the video signal includes a 2D image signal and a 3D image signal, includes a 2D image signal only or includes a 3D image signal only. It will be described later in further detail how the control unit 170 processes a 2D image signal or a 3D image signal with reference to FIG. 3. The control unit 170 may adjust the brightness, tint and color of the video signal.

The processed video signal provided by the control unit 170 may be transmitted to the display unit 180 and may thus be displayed by the display unit 180. Then, the display unit 180 may display an image corresponding to the processed video signal provided by the control unit 170. The processed video signal provided by the control unit 170 may also be transmitted to an external output device via the external signal I/O unit 130.

The control unit 170 may process the audio signal obtained by demultiplexing the input stream signal. For example, if the audio signal is an encoded signal, the control unit 170 may decode the audio signal. More specifically, if the audio signal is an MPEG-2 encoded signal, the control unit 170 may decode the audio signal by performing MPEG-2 decoding. On the other hand, if the audio signal is an MPEG-4 Bit Sliced Arithmetic Coding (BSAC)-encoded terrestrial DMB signal, the control unit 170 may decode the audio signal by performing MPEG-4 decoding. On the other hand, if the audio signal is an MPEG-2 Advanced Audio Coding (AAC)-encoded DMB or DVB-H signal, the controller 180 may decode the audio signal by performing AAC decoding. In addition, the control unit 170 may adjust the base, treble or sound volume of the audio signal.

The processed audio signal provided by the control unit 170 may be transmitted to the audio output unit 185. The processed audio signal provided by the control unit 170 may also be transmitted to an external output device via the external signal I/O unit 130.

The control unit 170 may process the data signal obtained by demultiplexing the input stream signal. For example, if the data signal is an encoded signal such as an electronic program guide (EPG), which is a guide to scheduled broadcast TV or radio programs, the control unit 170 may decode the data signal. Examples of an EPG include ATSC-Program and System Information Protocol (PSIP) information and DVB-Service Information (SI). ATSC-PSIP information or DVB-SI information may be included in the header of a transport stream (TS), i.e., a 4-byte header of an MPEG-2 TS.

The control unit 170 may perform on-screen display (OSD) processing. More specifically, the control unit 170 may generate an OSD signal for displaying various information on the display device 180 as graphic or text data based on a user input signal provided by the remote control device 200 or at least one of a processed video signal and a processed data signal. The OSD signal may be transmitted to the display unit 180 along with the processed video signal and the processed data signal.

The OSD signal may include various data such as a user-interface (UI) screen for the image display apparatus 100 and various menu screens, widgets, and icons.

The control unit 170 may generate the OSD signal as a 2D image signal or a 3D image signal, and this will be described later in further detail with reference to FIG. 3.

The control unit 170 may receive the analog baseband A/V signal CVBS/SIF from the tuner unit 110 or the external signal I/O unit 130. An analog baseband video signal processed by the control unit 170 may be transmitted to the display unit 180, and may then be displayed by the display unit 180. On the other hand, an analog baseband audio signal processed by the control unit 170 may be transmitted to the audio output unit 185 (e.g., a speaker) and may then be output through the audio output unit 185.

The image display apparatus 100 may also include a channel-browsing processing unit (not shown) that generates a thumbnail image corresponding to a channel signal or an externally-input signal. The channel-browsing processing unit may receive the stream signal TS from the demodulation unit 120 or the external signal I/O unit 130, may extract an image from the stream signal TS, and may generate a thumbnail image based on the extracted image. The thumbnail image generated by the channel-browsing processing unit may be transmitted to the control unit 170 as it is without being encoded. Alternatively, the thumbnail image generated by the channel-browsing processing unit may be encoded, and the encoded thumbnail image may be transmitted to the control unit 170. The control unit 170 may display a thumbnail list including a number of thumbnail images input thereto on the display unit 180.

The control unit 170 may receive a signal from the remote control device 200 via the interface unit 150. Thereafter, the control unit 170 may identify a command input to the remote control device 200 by a user based on the received signal, and may control the image display apparatus 100 in accordance with the identified command. For example, if a user inputs a command to select a predetermined channel, the control unit 170 may control the tuner unit 110 to receive a video signal, an audio signal and/or a data signal from the predetermined channel, and may process the signal(s) received by the tuner unit 110. Thereafter, the control unit 170 may control channel information regarding the predetermined channel to be output through the display unit 180 or the audio output unit 185 along with the processed signal(s).

A user may input may input a command to display various types of A/V signals to the image display apparatus 100. If a user wishes to watch a camera or camcorder image signal received by the external signal I/O unit 130, instead of a broadcast signal, the control unit 170 may control a video signal or an audio signal to be output via the display unit 180 or the audio output unit 185.

The control unit 170 may identify a user command input to the image display apparatus 100 via a number of local keys, which is included in the sensing unit, and may control the image display apparatus 100 in accordance with the identified user command. For example, a user may input various commands such as a command to turn on or off the image display apparatus 100, a command to switch channels, or a command to change volume to the image display apparatus 100 using the local keys. The local keys may include buttons or keys provided at the image display apparatus 100. The control unit 170 may determine how the local keys have been manipulated by a user, and may control the image display apparatus 100 according to the results of the determination.

The display unit 180 may convert a processed video signal, a processed data signal, and an OSD signal provided by the control unit 170 or a video signal and a data signal provided by the external signal I/O unit 130 into RGB signals, thereby generating driving signals. The display unit 180 may be implemented into various types of displays such as a plasma display panel, a liquid crystal display (LCD), an organic light-emitting diode (OLED), a flexible display, and a three-dimensional (3D) display. The display unit 180 may be classified into an additional display or an independent display. The independent display is a display device capable of displaying a 3D image without a requirement of additional display equipment such as glasses. Examples of the independent display include a lenticular display and parallax barrier display. On the other hand, the additional display is a display device capable of displaying a 3D image with the aid of additional display equipment. Examples of the additional display include a head mounted display (HMD) and an eyewear display (such as a polarized glass-type display, a shutter glass display, or a spectrum filter-type display).

The display unit 180 may also be implemented as a touch screen and may thus be used not only as an output device but also as an input device.

The audio output unit 185 may receive a processed audio signal (e.g., a stereo signal, a 3.1-channel signal or a 5.1-channel signal) from the control unit 170 and may output the received audio signal. The audio output unit 185 may be implemented into various types of speakers.

The remote control device 200 may transmit a user input to the interface 150. For this, the remote control device 200 may use various communication techniques such as Bluetooth, RF, IR, UWB and ZigBee.

The remote control device 100 may receive a video signal, an audio signal or a data signal from the interface unit 150, and may output the received signal.

The image display apparatus 100 may also include the sensor unit. The sensor unit may include a touch sensor, an acoustic sensor, a position sensor, and a motion sensor.

The touch sensor may be a touch screen of the display unit 180. The touch sensor may sense where on the touch screen and with what intensity a user is touching The acoustic sensor may sense the voice of a user various sounds generated by a user. The position sensor may sense the position of a user. The motion sensor may sense a gesture generated by a user. The position sensor or the motion sensor may include an infrared detection sensor or camera, and may sense the distance between the image display apparatus 100 and a user, and any hand gestures made by the user.

The sensor unit may transmit various sensing results provided by the touch sensor, the acoustic sensor, the position sensor and the motion sensor to a sensing signal processing unit (not shown). Alternatively, the sensor unit may analyze the various sensing results, and may generate a sensing signal based on the results of the analysis. Thereafter, the sensor unit may provide the sensing signal to the control unit 170.

The sensing signal processing unit may process the sensing signal provided by the sensing unit, and may transmit the processed sensing signal to the control unit 170.

The image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs or may be a mobile digital broadcast receiver capable of receiving at least one of terrestrial DMB broadcast programs, satellite DMB broadcast programs, ATSC-M/H broadcast programs, DVB-H (COFDM) broadcast programs, and Media Forward Link Only (MediaFLO) broadcast programs. Alternatively, the image display apparatus 100 may be a digital broadcast receiver capable of receiving cable broadcast programs, satellite broadcast programs or IPTV programs.

Examples of the image display apparatus 100 include a TV receiver, a mobile phone, a smart phone, a laptop computer, a digital broadcast receiver, a personal digital assistant (PDA) and a portable multimedia player (PMP).

The structure of the image display apparatus 100 shown in FIG. 1 is exemplary. The elements of the image display apparatus 100 may be incorporated into fewer modules, new elements may be added to the image display apparatus 100 or some of the elements of the image display apparatus 100 may not be provided. That is, two or more of the elements of the image display apparatus 100 may be incorporated into a single module, or some of the elements of the image display apparatus 100 may each be divided into two or more smaller units. The functions of the elements of the image display apparatus 100 are also exemplary, and thus do not put any restrictions on the scope of the present invention.

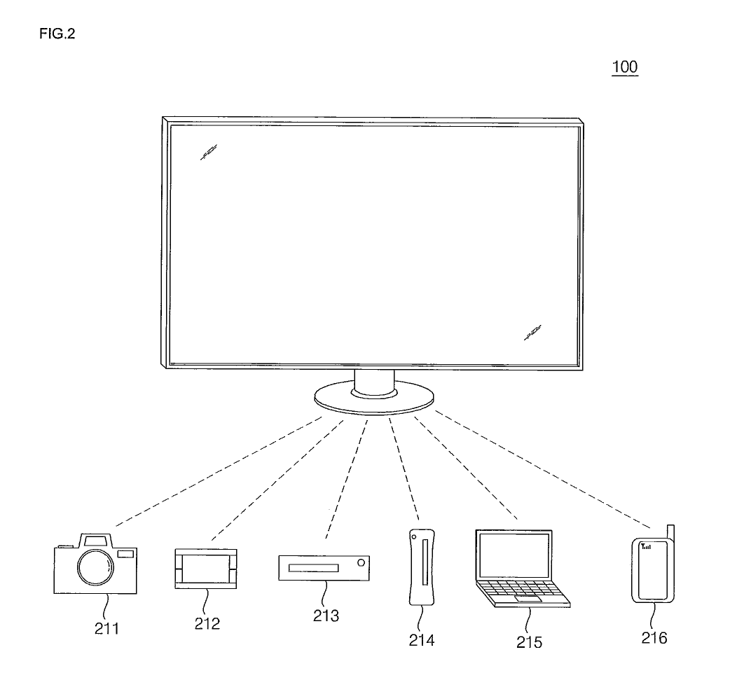

FIG. 2 illustrates examples of an external device that can be connected to the image display apparatus 100. Referring to FIG. 3, the image display apparatus 100 may be connected either non-wirelessly or wirelessly to an external device via the external signal I/O unit 130.

Examples of the external device to which the image display apparatus 100 may be connected include a camera 211, a screen-type remote control device 212, a set-top box 213, a gaming device 214, a computer 215 and a mobile communication terminal 216.

When connected to an external device via the external signal I/O unit 130, the image display apparatus 100 may display a graphic user interface (GUI) screen provided by the external device on the display unit 180. Then, a user may access both the external device and the image display apparatus 100 and may thus be able to view video data currently being played by the external device or video data present in the external device from the image display apparatus 100. In addition, the image display apparatus 100 may output audio data currently being played by the external device or audio data present in the external device via the audio output unit 185.

Various data, for example, still image files, moving image files, music files or text files, present in an external device to which the image display apparatus 100 is connected via the external signal I/O unit 130 may be stored in the storage unit 140 of the image display apparatus 100. In this case, even after disconnected from the external device, the image display apparatus 100 can output the various data stored in the storage unit 140 via the display unit 180 or the audio output unit 185.

When connected to the mobile communication terminal 216 or a communication network via the external signal I/O unit 130, the image display apparatus 100 may display a screen for providing a video or voice call service on the display unit 180 or may output audio data associated with the provision of the video or voice call service via the audio output unit 185. Thus, a user may be allowed to make or receive a video or voice call with the image display apparatus 100, which is connected to the mobile communication terminal 216 or a communication network.

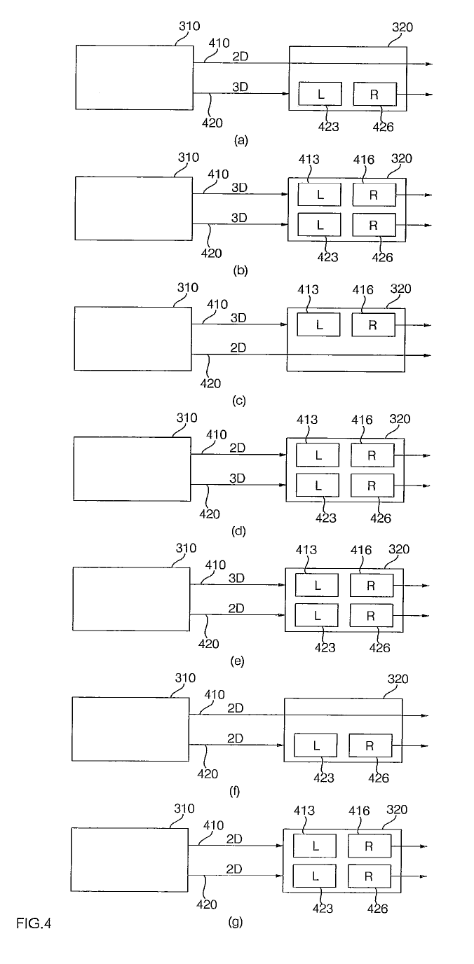

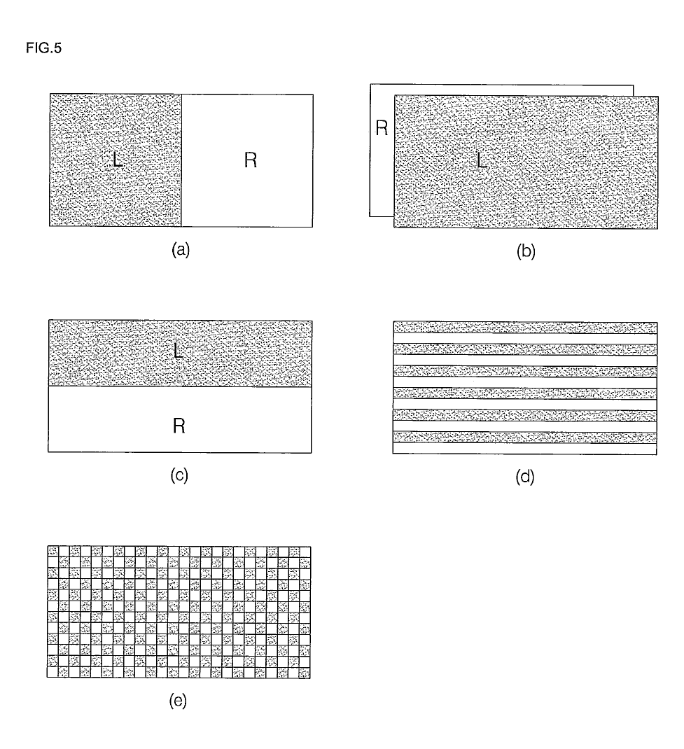

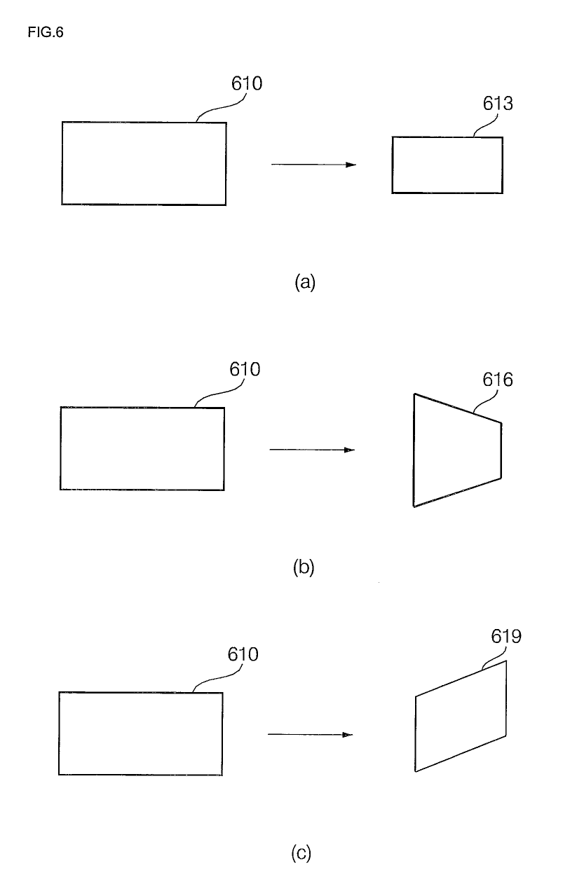

FIGS. 3(a) and 3(b) illustrate block diagrams of the control unit 170, FIGS. 4(a) through 4(g) illustrate how a formatter 320 shown in FIG. 3(a) or 3(b) separates a 2-dimensional (2D) image signal and a 3-dimensional (3D) image signal, FIGS. 5(a) through 5(e) illustrate various examples of the format of a 3D image output by the formatter 320, and FIGS. 6(a) through 6(c) illustrate how to scale a 3D image output by the formatter 320.

Referring to FIG. 3(a), the control unit 170 may include an image processor 310, the formatter 320, an on-screen display (OSD) generator 330 and a mixer 340.

Referring to FIG. 3(a), the image processor 310 may decode an input image signal, and may provide the decoded image signal to the formatter 320. Then, the formatter 320 may process the decoded image signal provided by the image processor 310 and may thus provide a plurality of perspective image signals. The mixer 340 may mix the plurality of perspective image signals provided by the formatter 320 and an image signal provided by the OSD generator 330.

More specifically, the image processor 310 may process both a broadcast signal processed by the tuner unit 110 and the demodulation unit 120 and an externally input signal provided by the external signal I/O unit 130.

The input image signal may be a signal obtained by demultiplexing a stream signal.

If the input image signal is, for example, an MPEG-2-encoded 2D image signal, the input image signal may be decoded by an MPEG-2 decoder.

On the other hand, if the input image signal is, for example, an H.264-encoded 2D DMB or DVB-H image signal, the input image signal may be decoded by an H.264 decoder.

On the other hand, if the input image signal is, for example, an MPEG-C part 3 image with disparity information and depth information, not only the input image signal but also the disparity information may be decoded by an MPEG-C decoder.

On the other hand, if the input image signal is, for example, a Multi-View Video Coding (MVC) image, the input image signal may be decoded by an MVC decoder.

On the other hand, if the input image signal is, for example, a free viewpoint TV (FTV) image, the input image signal may be decoded by an FTV decoder.

The decoded image signal provided by the image processor 310 may include a 2D image signal only, include both a 2D image signal and a 3D image signal or include a 3D image signal only.

The decoded image signal provided by the image processor 310 may be a 3D image signal with various formats. For example, the decoded image signal provided by the image processor 310 may be a 3D image including a color image and a depth image or a 3D image including a plurality of perspective image signals. The plurality of perspective image signals may include a left-eye image signal L and a right-eye image signal R. The left-eye image signal L and the right-eye image signal R may be arranged in various formats such as a side-by-side format shown in FIG. 5(a), a top-down format shown in FIG. 5(b), a frame sequential format shown in FIG. 5(c), an interlaced format shown in FIG. 5(d), or a checker box format shown in FIG. 5(e).

If the input image signal includes caption data or an image signal associated with data broadcasting, the image processor 310 may separate the caption data or the image signal associated with data broadcasting from the input image signal and may output the caption data or the image signal associated with data broadcasting to the OSD generator 330. Then, the OSD generator 330 may generate 3D objects based on the caption data or the image signal associated with data broadcasting.

The formatter 320 may receive the decoded image signal provided by the image processor 310, and may separate a 2D image signal and a 3D image signal from the received decoded image signal. The formatter 320 may divide a 3D image signal into a plurality of view signals, for example, a left-eye image signal and a right-eye image signal.

It may be determined whether the decoded image signal provided by the image processor 310 is a 2D image signal or a 3D image signal based on whether a 3D image flag, 3D image metadata, or 3D image format information is included in the header of a corresponding stream.

The 3D image flag, the 3D image metadata or the 3D image format information may include not only information regarding a 3D image but also may include location information, region information or size information of the 3D image. The 3D image flag, the 3D image metadata or the 3D image format information may be decoded, and the decoded 3D image flag, the decoded image metadata or the decoded 3D image format information may be transmitted to the formatter 320 during the demultiplexing of the corresponding stream.

The formatter 320 may separate a 3D image signal from the decoded image signal provided by the image processor 310 based on the 3D image flag, the 3D image metadata or the 3D image format information. The formatter 320 may divide the 3D image signal into a plurality of perspective image signals with reference to the 3D image format information. For example, the formatter 320 may divide the 3D image signal into a left-eye image signal and a right-eye image signal based on the 3D image format information.

Referring to FIGS. 4(a) through 4(g), the formatter 320 may separate a 2D image signal and a 3D image signal from the decoded image signal provided by the image processor 310 and may then divide the 3D image signal into a left-eye image signal and a right-eye image signal.

More specifically, referring to FIG. 4(a), if a first image signal 410 is a 2D image signal and a second image signal 420 is a 3D image signal, the formatter 320 may separate the first and second image signals 410 and 420 from each other, and may divide the second image signal 420 into a left-eye image signal 423 and a right-eye image signal 426. The first image signal 410 may correspond to a main image to be displayed on the display unit 180, and the second image signal 420 may correspond to a picture-in-picture (PIP) image to be displayed on the display unit 180.

Referring to FIG. 4(b), if the first and second image signals 410 and 420 are both 3D image signals, the formatter 320 may separate the first and second image signals 410 and 420 from each other, may divide the first image signal 410 into a left-eye image signal 413 and a right-eye image signal 416, and may divide the second image signal 420 into the left-eye image signal 423 and the right-eye image signal 426.

Referring to FIG. 4(c), if the first image signal 410 is a 3D image signal and the second image signal 420 is a 2D image signal, the formatter 320 may divide the first image signal into the left-eye image signal 413 and the right-eye image signal 416.

Referring to FIGS. 4(d) and 4(e), if one of the first and second image signals 410 and 420 is a 3D image signal and the other image signal is a 2D image signal, the formatter 320 may convert whichever of the first and second image signals 410 and 420 is a 2D image signal into a 3D image signal in response to, for example, user input. More specifically, the formatter 320 may convert a 2D image signal into a 3D image signal by detecting edges from the 2D image signal using a 3D image creation algorithm, extracting an object with the detected edges from the 2D image signal, and generating a 3D image signal based on the extracted object. Alternatively, the formatter 320 may convert a 2D image signal into a 3D image signal by detecting an object, if any, from the 2D image signal using a 3D image generation algorithm and generating a 3D image signal based on the detected object. Once a 2D image signal is converted into a 3D image signal, the formatter 320 may divide the 3D image signal into a left-eye image signal and a right-eye image signal. A 2D image signal except for an object to be reconstructed as a 3D image signal may be output as a 2D image signal.

Referring to FIG. 4(f), if the first and second image signals 410 and 420 are both 2D image signals, the formatter 320 may convert only one of the first and second image signals 410 and 420 into a 3D image signal using a 3D image generation algorithm. Alternatively, referring to FIG. 4G, the formatter 320 may convert both the first and second image signals 410 and 420 into 3D image signals using a 3D image generation algorithm.

If there is a 3D image flag, 3D image metadata or 3D image format information available, the formatter 320 may determine whether the decoded image signal provided by the image processor 310 is a 3D image signal with reference to the 3D image flag, the 3D image metadata or the 3D image format information. On the other hand, if there is no 3D image flag, 3D image metadata or 3D image format information available, the formatter 320 may determine whether the decoded image signal provided by the image processor 310 is a 3D image signal by using a 3D image generation algorithm.

A 3D image signal provided by the image processor 310 may be divided into a left-eye image signal and a right-eye image signal by the formatter 320. Thereafter, the left-eye image signal and the right-eye image signal may be output in one of the formats shown in FIGS. 5(a) through 5(e). A 2D image signal provided by the image processor 310, however, may be output as is without the need to be processed or may be transformed and thus output as a 3D image signal.

As described above, the formatter 320 may output a 3D image signal in various formats. More specifically, referring to FIGS. 5(a) through 5(e), the formatter 320 may output a 3D image signal in a side-by-side format, a top-down format, a frame sequential format, an interlaced format, in which a left-eye image signal and a right-eye image signal are mixed on a line-by-line basis, or a checker box format, in which a left-eye image signal and a right-eye image signal are mixed on a box-by-box basis.

A user may select one of the formats shown in FIGS. 5(a) through 5(e) as an output format for a 3D image signal. For example, if a user selects the top-down format, the formatter 320 may reconfigure a 3D image signal input thereto, divide the input 3D image signal into a left-eye image signal and a right-eye image signal, and output the left-eye image signal and the right-eye image signal in the top-down format regardless of the original format of the input 3D image signal.

A 3D image signal input to the formatter 320 may be a broadcast image signal, an externally-input signal or a 3D image signal with a predetermined depth level. The formatter 320 may divide the 3D image signal into a left-eye image signal and a right-eye image signal.

Left-eye image signals or right-eye image signals extracted from 3D image signals having different depths may differ from one another. That is, a left-eye image signal or a right-eye image signal extracted from a 3D image signal or the disparity between the extracted left-eye image signal and right-eye image signal may change according to the depth of the 3D image signal.

If the depth of a 3D image signal is changed in accordance with a user input or user settings, the formatter 320 may divide the 3D image signal into a left-eye image signal and a right-eye image signal in consideration of the changed depth.

The formatter 320 may scale a 3D image signal, and particularly, a 3D object in a 3D image signal, in various manners.

More specifically, referring to FIG. 6(a), the formatter 320 may generally enlarge or reduce a 3D image signal or a 3D object in the 3D image signal. Alternatively, referring to FIG. 6(b), the formatter 320 may partially enlarge or reduce the 3D image signal or the 3D object into a trapezoid. Alternatively, referring to FIG. 6(c), the formatter 320 may rotate the 3D image signal or the 3D object and thus transform the 3D object or the 3D object into a parallelogram. In this manner, the formatter 320 may add a sense of three-dimensionality to the 3D image signal or the 3D object and may thus emphasize a 3D effect. The 3D image signal may be a left-eye image signal or a right-eye image signal of the second image signal 420. Alternatively, the 3D image signal may be a left-eye image signal or a right-eye image signal of a PIP image.

In short, the formatter 320 may receive the decoded image signal provided by the image processor 310, may separate a 2D image signal or a 3D image signal from the received image signal, and may divide the 3D image signal into a left-eye image signal and a right-eye image signal. Thereafter, the formatter 320 may scale the left-eye image signal and the right-eye image signal and may then output the results of the scaling in one of the formats shown in FIGS. 5(a) through 5(e). Alternatively, the formatter 320 may rearrange the left-eye image signal and the right-eye image signal in one of the formats shown in FIGS. 5(a) through 5(e) and may then scale the result of the rearrangement.

Referring to FIG. 3(a), the OSD generator 330 may generate an OSD signal in response to or without user input. The OSD signal may include a 2D OSD object or a 3D OSD object.

It may be determined whether the OSD signal includes a 2D OSD object or a 3D OSD object based on user input, the size of the object or whether the OSD object of the OSD signal is an object that can be selected.

The OSD generator 330 may generate a 2D OSD object or a 3D OSD object and output the generated OSD object, whereas the formatter 320 merely processes the decoded image signal provided by the image processor 310. A 3D OSD object may be scaled in various manners, as shown in FIGS. 6(a) through 6(c). The type or shape of a 3D OSD object may vary according to the depth at which the 3D OSD is displayed.

The OSD signal may be output in one of the formats shown in FIGS. 5(a) through 5(e). More specifically, the OSD signal may be output in the same format as that of an image signal output by the formatter 320. For example, if a user selects the top-down format as an output format for the formatter 320, the top-down format may be automatically determined as an output format for the OSD generator 330.

The OSD generator 330 may receive a caption- or data broadcasting-related image signal from the image processor 310, and may output a caption- or data broadcasting-related OSD signal. The caption- or data broadcasting-related OSD signal may include a 2D OSD object or a 3D OSD object.

The mixer 340 may mix an image signal output by the formatter 320 with an OSD signal output by the OSD generator 330, and may output an image signal obtained by the mixing The image signal output by the mixer 340 may be transmitted to the display unit 180.

The control unit 170 may have a structure shown in FIG. 3(b). Referring to FIG. 3(b), the control unit 170 may include an image processor 310, a formatter 320, an OSD generator 330 and a mixer 340. The image processor 310, the formatter 320, the OSD generator 330 and the mixer 340 are almost the same as their respective counterparts shown in FIG. 3(a), and thus will hereinafter be described, focusing mainly on differences with their respective counterparts shown in FIG. 3(a).

Referring to FIG. 3(b), the mixer 340 may mix a decoded image signal provided with the image processor 310 with an OSD signal provided by the OSD generator 330, and then, the formatter 320 may process an image signal obtained by the mixing performed by the mixer 340. Thus, the OSD generator 330 shown in FIG. 3(b), unlike the OSD generator 330 shown in FIG. 3(a), does no need to generate a 3D object. Instead, the OSD generator 330 may simply generate an OSD signal corresponding to any given 3D object.

Referring to FIG. 3(b), the formatter 320 may receive the image signal provided by the mixer 340, may separate a 3D image signal from the received image signal, and may divide the 3D image signal into a plurality of perspective image signals. For example, the formatter 320 may divide a 3D image signal into a left-eye image signal and a right-eye image signal, may scale the left-eye image signal and the right-eye image signal, and may output the scaled left-eye image signal and the scaled right-eye image signal in one of the formats shown in FIGS. 5(a) through 5(e).

The structure of the control unit 170 shown in FIG. 3(a) or 3(b) is exemplary. The elements of the control unit 170 may be incorporated into fewer modules, new elements may be added to the control unit 170 or some of the elements of the control unit 170 may not be provided. That is, two or more of the elements of the control unit 170 may be incorporated into a single module, or some of the elements of the control unit 170 may each be divided into two or more smaller units. The functions of the elements of the control unit 170 are also exemplary, and thus do not put any restrictions on the scope of the present invention.

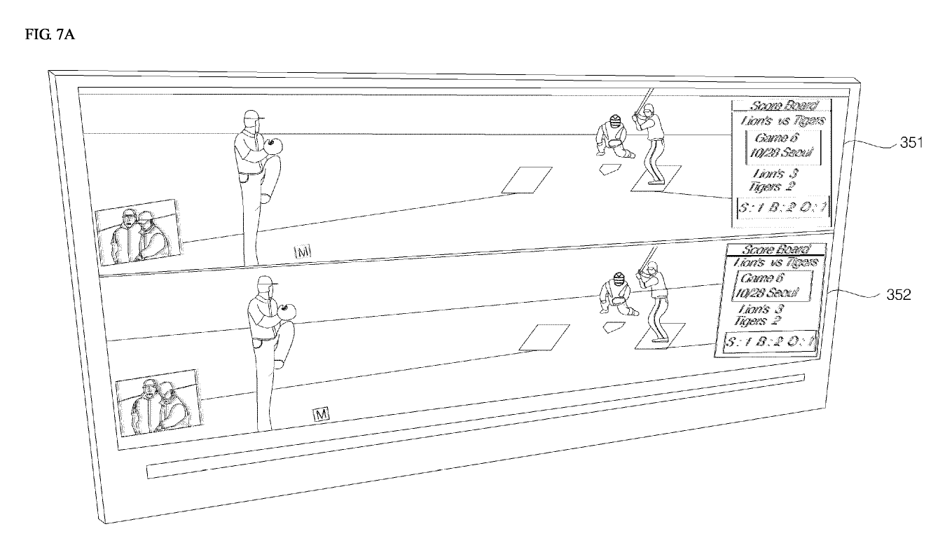

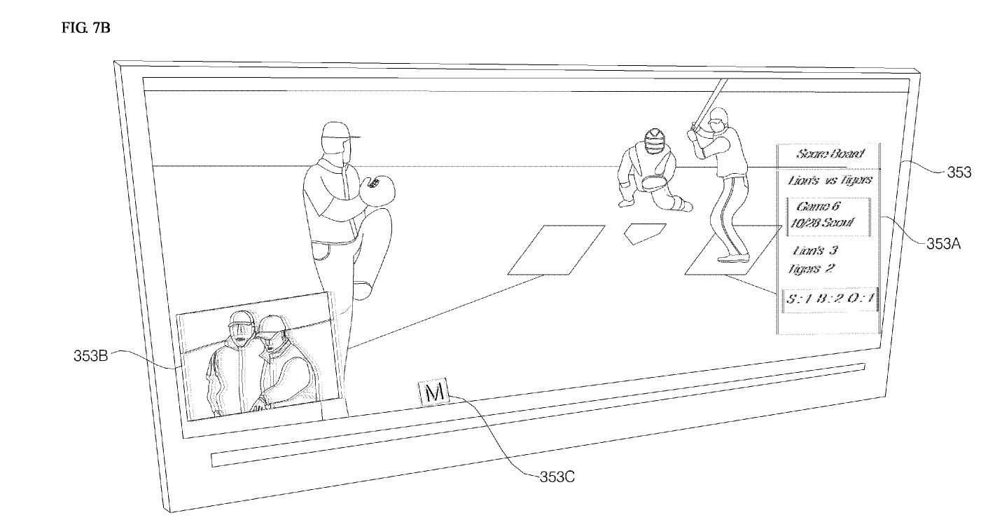

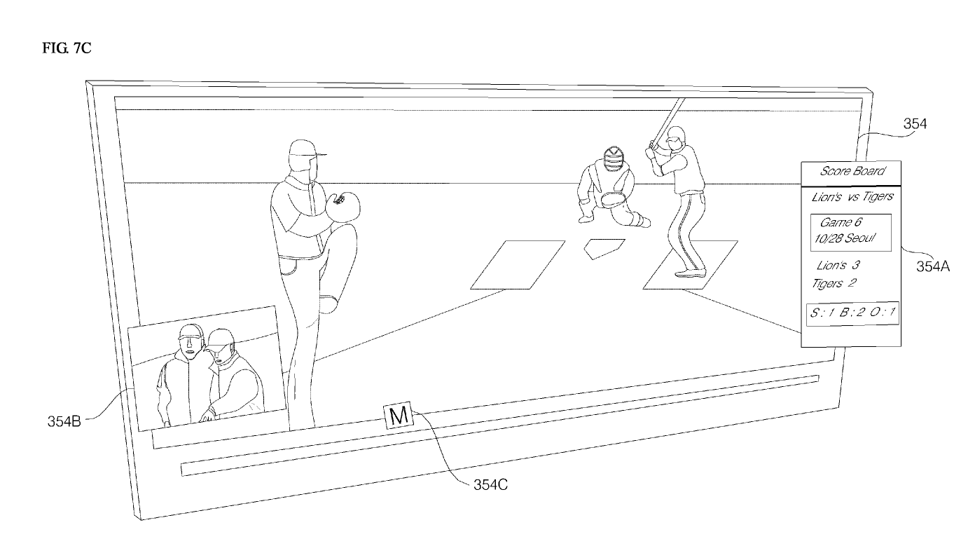

FIGS. 7A through 7C illustrate various images that can be displayed by the image display apparatus 100. Referring to FIGS. 7A through 7C, the image display apparatus 100 may display a 3D image in one of the formats shown in FIGS. 5(a) through 5(e), e.g., the top-down format.

More specifically, referring to FIG. 7A, when the play of video data is terminated, the image display apparatus 100 may display two perspective images 351 and 352 in the top-down format so that the two perspective images 351 and 352 can be arranged side by side vertically on the display unit 180.

The image display apparatus 100 may display a 3D image on the display unit 180 using a method that requires the use of polarized glasses to properly view the 3D image. In this case, when viewed without polarized glasses, the 3D image and 3D objects in the 3D image may not appear in focus, as indicated by reference numerals 353 and 353A through 353C.

On the other hand, when viewed with polarized glasses, not only the 3D image but also the 3D objects in the 3D image may appear in focus, as indicated by reference numerals 354 and 354A through 354C. The 3D objects in the 3D image may be displayed as if protruding beyond the 3D image.

If the image display apparatus 100 displays a 3D image using a method that does not require the use of polarized glasses to properly view the 3D image, the 3D image and 3D objects in the 3D image may all appear in focus even when viewed without polarized glasses, as shown in FIG. 7C.

The term ‘object,’ as used herein, includes various information regarding the image display apparatus 100 such as audio output level information, channel information, or current time information and an image or text displayed by the image display apparatus 100.

For example, a volume control button, a channel button, a control menu, an icon, a navigation tab, a scroll bar, a progressive bar, a text box and a window that can be displayed on the display unit 180 of the image display apparatus 100 may be classified as objects.

A user may acquire information regarding the image display apparatus 100 or information regarding an image displayed by the image display apparatus 100 from various objects displayed by the image display apparatus 100. In addition, a user may input various commands to the image display apparatus 100 through various objects displayed by the image display apparatus 100.

When a 3D object has as positive depth level, it may be displayed as if protruding toward a user. The depth on the display module 180 or the depth of a 2D image or a 3D image displayed on the display unit 180 may be set to 0. When a 3D object has a negative depth level, it may be displayed as if recessed into the display unit 180. As a result, the greater the depth of a 3D object is, the more the 3D object appears protruding toward a user.

The term ‘3D object,’ as used herein, includes various objects generated through, for example, a scaling operation, which has already been described above with reference to FIGS. 6(a) through 6(c), so as to create a sense of three-dimensionality or the illusion of depth.

FIG. 7C illustrates a PIP image as an example of a 3D object, but the present invention is not restricted to this. That is, electronic program guide (EPG) data, various menus provided by the image display apparatus 100, widgets or icons may also be classified as 3D objects.

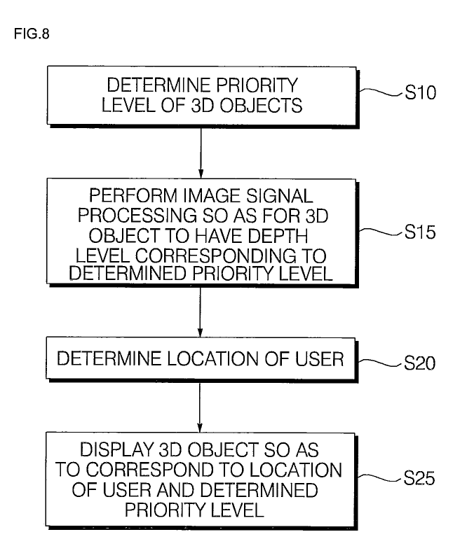

FIG. 8 illustrates a flowchart of an operating method of an image display apparatus according to a first exemplary embodiment of the present invention. Referring to FIG. 8, if a 3D object display event, which is an event that requires the display of a 3D object, occurs, the image display apparatus 100 may determine the priority level of a 3D object to be displayed in connection with the 3D object display event (S10). Thereafter, the image display apparatus 100 may process an image signal corresponding to the 3D object such that the 3D object can be displayed at a depth level corresponding to the determined priority level (S15).

The 3D object display event may occur in response to the input of a 3D object display command to the image display apparatus 100 by a user. The 3D object display event may also occur in response to a predetermined signal received by the image display apparatus 100 or upon the arrival of a predetermined scheduled time.

The priority level of the 3D object to be displayed in connection with the 3D object display event may be determined differently according to the type of the 3D object display event. For example, if a command to display photos is input to the image display apparatus 1000, an event for displaying photos may occur. The event for displaying photos may involve displaying photos present in the image display apparatus 100 or in an external device to which the image display apparatus 100 is connected. In one embodiment, the priority levels of 3D objects corresponding to the photos may be determined according to the dates when the photos were saved. For example, the priority level of a 3D object corresponding to a recently-saved photo may be higher than the priority level of a 3D object corresponding to a less recently-saved photo. In other embodiments, other criteria or meta-data may be used to set the priority levels of the 3D objects. For example, priority levels of the 3D objects may be determined according to an alphabetical order of the file names of the photos. For example, the priority level of a 3D object corresponding to a photo with a file name starting with ‘A’ may be higher than the priority level of a 3D object corresponding to a photo with a file name starting with ‘B’ or ‘C.’

Alternatively, if a search word is input to the image display apparatus 100 via the internet, an event for displaying search results that are relevant to the input search word may occur. In this case, the priority levels of 3D objects corresponding to the search results may be determined according to the relevance of the search results to the search word. For example, the priority level of a 3D object corresponding to a search result that is most relevant to the search word may be higher than the priority level of a 3D object corresponding to a search result that is less relevant to the search word.

Still alternatively, if an incoming call is received when the image display apparatus 100 is connected to a telephone network, a popup window indicating the incoming call may be displayed as a 3D object. The control unit 170 may determine the priority level of the 3D object corresponding to the popup window, and may process a corresponding image signal so that the 3D object can be displayed on the display unit 180 at a depth level corresponding to the determined priority level.

A user may determine or change the priority level of a 3D object. For example, a user may set the priority level of a 3D object for displaying a channel browser-related menu as a highest priority-3D object. Then, the control unit 170 may process an image signal corresponding to the 3D object for displaying a channel browser-related menu such that the 3D object for displaying a channel browser-related menu can be displayed with a different depth level from other 3D objects. Since the 3D object for displaying a channel browser-related menu has a highest priority level, the control unit 170 may display the 3D object for displaying a channel browser-related menu so as to appear more protruding than other 3D objects toward a user.

The image display apparatus 100 may display a 3D object so as to appear as if the 3D object were directly located in front of a predetermined reference point. The predetermined reference point may be a user who is watching the image display apparatus 100. In this case, the image display apparatus 100 may need to determine the location of the user. More specifically, the image display apparatus 100 may determine the location of the user, and particularly, the positions of the eyes or hands of the user, using the position or motion sensor of the sensor unit or using a sensor attached onto the body of the user. The sensor attached onto the body of the user may be a pen or a remote control device.

Referring to FIG. 8, the image display apparatus 100 may determine the location of a user (S20). Thereafter, the image display apparatus 100 may display a 3D object so as for the user to feel as if the 3D object were located directly ahead (S25). The image display apparatus 100 may change the depth of the 3D object according to the priority level of the 3D object. That is, the control unit 170 may process an image signal corresponding to a 3D object such that the 3D object can appear as if protruding the most toward the user.

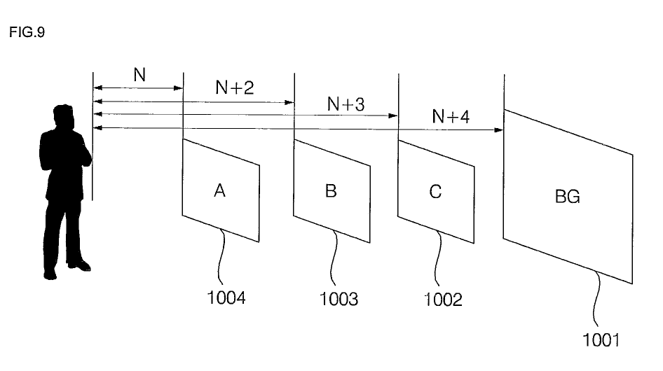

FIG. 9 illustrates a diagram for explaining an operating method of an image display apparatus according to a second exemplary embodiment of the present invention. Referring to FIG. 9, 3D objects 1002, 1003 and 1004 having different priority levels may be displayed at different depths. The 3D objects 1002, 1003 and 1004 may have different depths from the depth of a background image 1001. The 3D objects 1002, 1003, and 1004 may appear as if protruding toward a user beyond the background image 1001.

The 3D objects 1002, 1003, and 1004 may have different depths from one another due to their different priority levels. The 3D object 1004 may have a higher priority level than the 3D objects 1002 and 1003. Thus, the control unit 170 may process an image signal corresponding to the 3D object 1004 such that the 3D object 1004 can appear as if located closer than the 3D objects 1002 and 1003 to the user. The 3D object 1004 may be displayed as if a distance N apart from the user.

The control unit 170 may process an image signal corresponding to the 3D object 1003 such that the 3D object 1003 having a second highest priority level can be displayed as if a distance N+2 apart from the user, and that the 3D object 1002 can be displayed as if a distance N+3 apart from the user.

The background image 1004, which is displayed as if a distance N+4 apart from the user, may be a main image, which is an image that the user wishes to view mainly or an image having a reference size or greater. If the main image is a 2D image, the depth of the main image may be 0. A 3D object displayed as if protruding toward the user may have a positive depth.

The user may input a command to the image display apparatus 100 by making, for example, a hand gesture, through one of the 3D objects 1002, 1003, and 1004, which are displayed as if protruding toward the user beyond the background image 1001.

The image display apparatus 100 may keep track of the position of the hand of the user with the aid of the motion sensor of the sensor unit, and may identify the hand gesture made by the user. The storage unit 140 may store a plurality of previously-set hand gestures for inputting various commands to the image display apparatus 100. If there is a match for the identified hand gesture in the storage unit 140, the image display apparatus 100 may determine that a command corresponding to the previously-set hand gesture that matches with the identified hand gesture has been input to the image display apparatus 100, and may perform an operation corresponding to the command determined to have been input to the image display apparatus 100.

The user may input a command to the image display apparatus 100 using the remote control device 200, instead of making a hand gesture. More specifically, the user may select one of the 3D objects 1002, 1003 and 1004 using the remote control device 200, and may then input a command to the image display apparatus 100 through the selected 3D object.

If the user makes a predetermined hand gesture or inputs a command to select a 3D object to the image display apparatus 100 using the remote control device 200, the image display apparatus 100 may determine that one of the 3D objects 1002, 1003 and 1004, for example, the 3D object 1004, which has a higher priority level than the 3D objects 1002 and 1003 and is thus displayed as if located closer than the 3D objects 1002 and 1003 to the user, has been selected.

For example, the 3D object 1004 may be an object for inputting a command to delete a 3D object currently being displayed and the 3D object 1003 may be an object for inputting a command to display a 3D object other than the 3D object currently being displayed. In this case, if the 3D object 1004 is selected in response to a predetermined hand gesture made by the user or a signal input to the image display apparatus 100 through the remote control device 200, the image display apparatus 100 may execute a command corresponding to the 3D object 1004, i.e., may delete all the 3D objects 1002, 1003 and 1004.

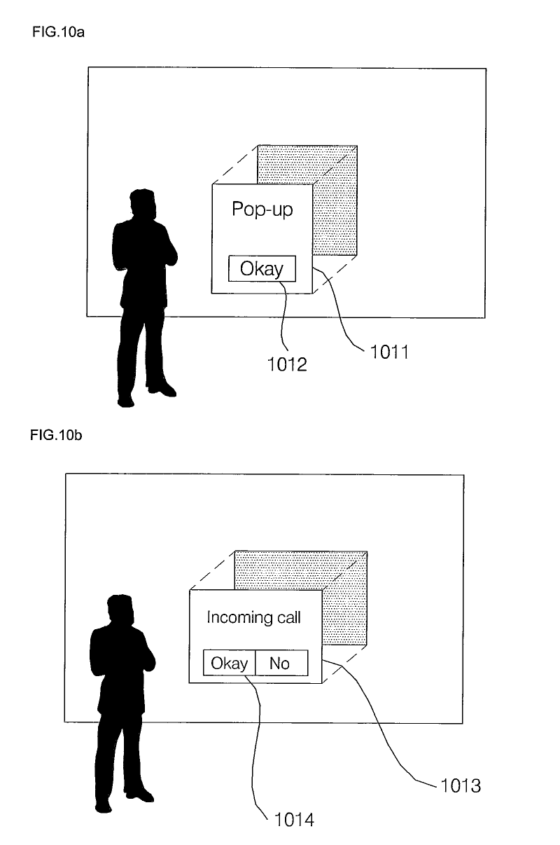

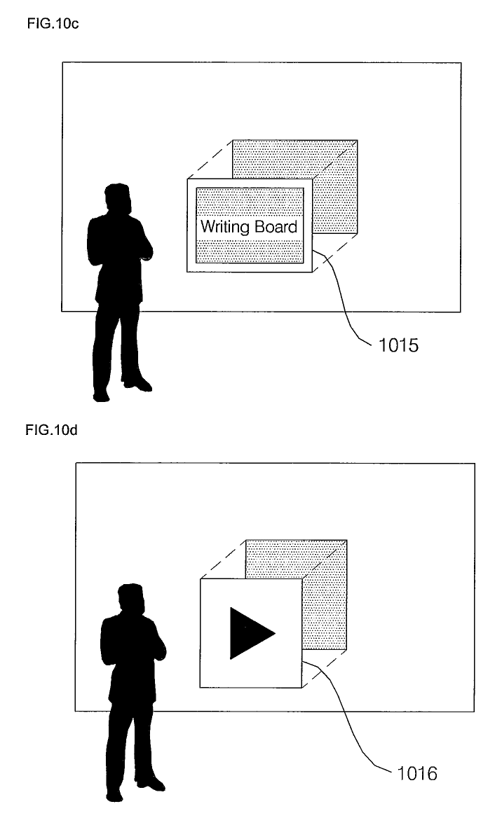

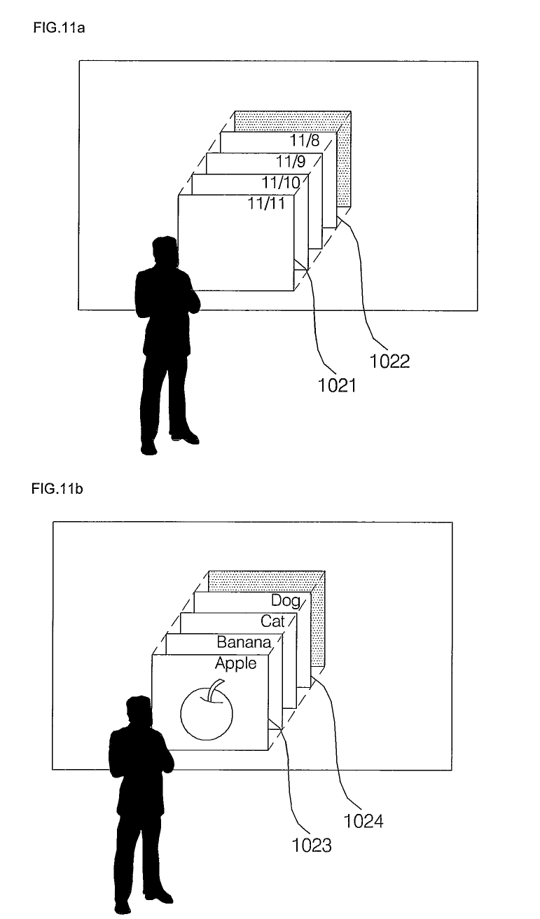

FIGS. 10A through 10D illustrate diagrams for explaining an operating method of an image display apparatus according to a third exemplary embodiment of the present invention. In the third exemplary embodiment, an image signal corresponding to a 3D object rendering a popup window or a function button may be processed such that the 3D object can be displayed as if located closer than other 3D objects to a user.

Referring to FIG. 10A, a popup window may be displayed in order to alert or warn a user of important information or warning situations in the image display apparatus 100 such as an unstable connection between the image display apparatus 100 and an external device. More specifically, a 3D object 1011 rendering a popup window may be displayed as if protruding toward the user. The depth of the 3D object 1011 may be determined by the importance of information provided by the popup window. Thus, the depth of the 3D object 1011 may vary according to the importance of information provided by the popup window. The image display apparatus 100 may determine the depth of the 3D object 1011 based on the priority level of the 3D object 1011.

The user may select an ‘Okay’ button 1012 in the 3D object 1011 by making a hand gesture. Then image display apparatus 100 may detect the hand gesture made by the user with the aid of a camera, and may determine whether the detected hand gesture matches with a previously-set hand gesture for selecting the ‘Okay’ button 1012. If the detected hand gesture matches with a previously-set hand gesture for selecting the ‘Okay’ button 1012, the image display apparatus 100 may perform an operation corresponding to the ‘Okay’ button 1012, i.e., may delete the 3D object 1011.

The priority level of the ‘Okay’ button 1012 may be higher than the priority level of the 3D object 1011. In this case, the depth of the ‘Okay’ button 1012 may be different from the depth of the 3D object 1011. Thus, the control unit 170 may process an image signal corresponding to the ‘Okay’ button 1012 such that the ‘Okay’ button 1012 can appear more protruding than the 3D object 1011 toward the user.

A 3D object having a highest priority level can be selected by a hand gesture made by the user. The priority level of the ‘Okay’ button 1012 may be higher than the priority level of the 3D object 1011. Thus, if there is a 3D object selected by a hand gesture made by the user, the control unit 170 may determine that the selected 3D object is the ‘Okay’ button 1012, and may perform the operation corresponding to the ‘Okay’ button 1012.

The user may input a 3D object-related command to the image display apparatus 100 not only by making a hand gesture but also by using a pen, a pointing device or the remote control device 200. The image display apparatus 100 may perform an operation corresponding to a command, if any, input thereto via the sensor unit or the interface unit 150.

Referring to FIG. 10B, if there is an incoming call received when the image display apparatus 100 is connected to a telephone network, a 3D object 1013 rendering a popup window for alerting a user to the incoming call may be displayed. The user may select an ‘Okay’ button 1014 in the 3D object 1013 by making a hand gesture. The control unit 170 may detect the hand gesture made by the user with the aid of the sensor unit, and may determine whether the detected hand gesture matches with a previously-set hand gesture for selecting the ‘Okay’ button 1014. Then, if the detected hand gesture matches with a previously-set hand gesture for selecting the ‘Okay’ button 1014, or if a command to select the ‘Okay’ button 1014 is received via the interface unit 150, the control unit 170 may control the image display apparatus 100 by performing an operation corresponding to the ‘Okay’ button 1014.

Referring to FIG. 10C, a 3D object 1015 rendering a handwriting board for allowing a user to handwrite may be displayed. The control unit 170 may process an image signal corresponding to the 3D object 1015 such that the 3D object 1015 can be displayed as if located directly in front of the user. The user may then input a command to the image display apparatus 100 through the 3D object 1015.

The handwriting board may allow the user to handwrite various commands that can be input to the image display apparatus 100. The user may handwrite on the 3D object 1015 with his or her hand or using a pen, a pointing device or the remote control device 200. Then, the control unit 170 may detect the hand gesture made by the user with the aid of the sensor unit, or may receive a signal, if any, input thereto via the interface unit 150. Thereafter, the control unit 170 may recognize a command handwritten by the user based on the detected gesture or the received signal, and may display the handwritten command on the handwriting board. Thus, the user may view the handwritten command from the 3D object 1015. The 3D object 1015 may be displayed as if tilted backward so as to facilitate handwriting.

Referring to FIG. 10D, a 3D object 1016 rendering a ‘play’ button may be displayed as if located directly in front of a user. The user may select the 3D object 1016 with a hand gesture or with a pen, a pointing device or the remote control device 200. If the user inputs a command to select the 3D object 1016 to the image display apparatus 100, the control unit 170 may control the image display apparatus 100 in accordance with the command. The 3D object 1016 may be displayed before the play of a moving image by the image display apparatus 100.

Referring to FIGS. 10A through 10D, the image display apparatus 100 may display a 3D object rendering a popup window or a function button. The priority level of a 3D object rendering a popup window or a function button may be determined by user or default setting. A 3D object rendering a popup window or a function button may have a higher priority level than other 3D objects. Thus, the control unit 170 may process an image signal corresponding to a 3D object rendering a popup window or a function button such that the 3D object can appear more protruding than other 3D objects toward a user.

If there is the need to display a popup window and a function button at the same time, the control unit 170 may change the depth of a 3D object rendering the popup window or a 3D object rendering the function button. For example, if information provided by the popup window is deemed more important than the function button, the control unit 170 may determine that the priority level of the 3D object rendering the popup window is higher than the priority level of the 3D object rendering the function button, and may process an image signal corresponding to the 3D object rendering the popup window and an image signal corresponding to the 3D object rendering the function button such that the 3D object rendering the popup window can be displayed as if closer than the 3D object rendering the function button to a user.

On the other hand, if the function button is deemed more important than the information provided by the popup window, the control unit 170 may determine that the priority level of the 3D object rendering the function button is higher than the priority level of the 3D object rendering the popup window, and may process the image signal corresponding to the 3D object rendering the popup window and the image signal corresponding to the 3D object rendering the function button such that the 3D object rendering the function button can be displayed as if closer than the 3D object rendering the popup window to a user.

A user may input a command to the image display apparatus 100 through a 3D object displayed as if located closer than other 3D objects or a background image displayed by the image display apparatus 100 to the user. In the third exemplary embodiment, a 3D object providing important information or rendering a function button may be displayed as if located directly in front of a user, thereby allowing the user to intuitively use the 3D object.

FIGS. 11A and 11B illustrate diagrams for explaining an operating method of an image display apparatus according to a fourth exemplary embodiment of the present invention. In the fourth exemplary embodiment, the control unit 170 may display a 3D object corresponding to a predetermined content item in response to a command input thereto by a user. The control unit 170 may change the depth of the 3D object in accordance with the priority level of the 3D object by adjusting the disparity between a left-eye image and a right-eye image of the 3D object with the aid of the formatter 320.

A user may identify various content items present in the image display apparatus 100 or in an external device to which the image display apparatus 100 is connected. The user may input a command to search for a predetermined content item to the image display apparatus 100.

The control unit 170 may detect a hand gesture, if any, made by the user with the aid of the sensor unit, and may determine whether a content search command or a content display command has been received from the user. Alternatively, the control unit 170 may receive a signal, if any, input thereto with the use of a pointing device or the remote control device 200 by the user, and may determine whether the content search command or the content display command has been received from the user.

If it is determined that the content search command or the content display command has been received from the user, the control unit 170 may perform signal processing such that a 3D object corresponding to a content item desired by the user can be displayed. If there are two or more content items desired by the user, the control unit 170 may determine the depths of 3D objects respectively corresponding to the desired content items based on the priority levels of the 3D objects.

The priority level of a 3D object corresponding to a content item may be determined in various manners. For example, the priority level of a 3D object corresponding to a content item may be determined by when the content item was saved. Alternatively, the priority level of a 3D object corresponding to a content item 3D may be determined by the file name of the content item. Still alternatively, the priority level of a 3D object corresponding to a content item may be determined by tag information of the content item.

FIG. 11A illustrates how to determine the priority level of a 3D object corresponding to a content item based on when the content item was saved. Referring to FIG. 11A, a 3D object 1021 corresponding to a most recently-saved content item may have having a highest priority level, and a 3D object 1022 corresponding to a least recently-saved content item may have a lowest priority level. The control unit 170 may process an image signal corresponding to the 3D object 1021, which has the highest priority level, such that the 3D object 1021 can be displayed as if protruding the most toward a user.

FIG. 11B illustrates how to determine the priority level of a 3D object corresponding to a content item 3D based on the file name of the content item. Referring to FIG. 11B, a 3D object 1023 corresponding to a file name starting with ‘A’ may have a highest priority level, and a 3D object 1024 corresponding to a file name starting with ‘D’ may have a lowest priority level.

Referring to FIGS. 11A and 11B, the control unit 170 may process an image signal corresponding to a 3D object and may thus allow the depth of the 3D object to vary according to the priority level of the 3D object. The priority level of a 3D object may vary. For example, the 3D object 1021, which was saved on November 11, may correspond to a content item with a file name ‘Dog.’ In this case, the 3D object 1021 may be determined to have a highest priority level based on the date the corresponding content item was saved, or may be determined to have a lowest priority level based on the file name of the corresponding content item. Thus, the depth of a 3D object corresponding to a content item may be altered in response to a command input by a user.

The priority level of a 3D object corresponding to a content item may be determined in various manners, other than those set forth herein. For example, if the content item is a photo, tag information specifying the place where the photo was taken may be provided along with the photo. Thus, the control unit 170 may determine the priority level of the 3D object based on the tag information.

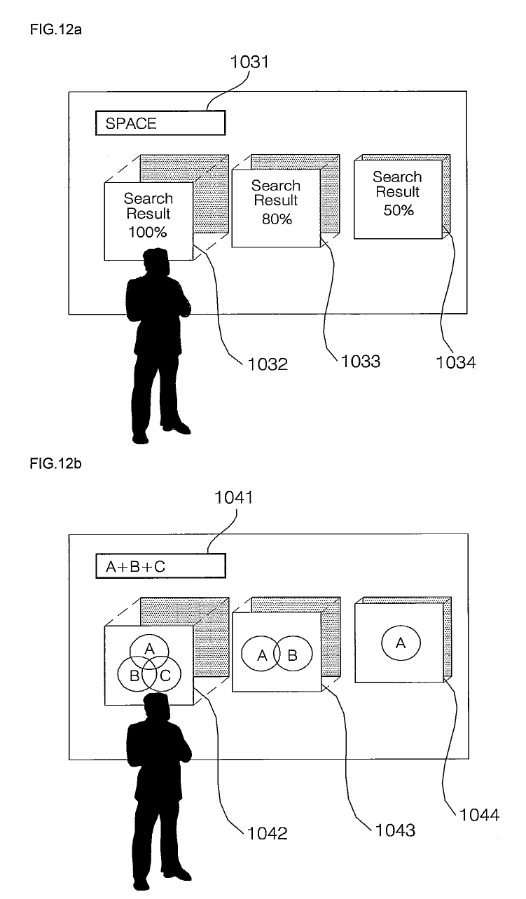

FIGS. 12A and 12B illustrate diagrams for explaining an operating method of an image display apparatus according to a fifth exemplary embodiment of the present invention. Referring to FIG. 12A, when the image display apparatus 100 is connected to the internet, the control unit 170 may display an internet browser screen on the display unit 180. A user may input a search word into a search window on the internet browser screen. The control unit 170 may then perform search based on the input search word, and may display search results as 3D objects. The control unit 170 may determine the priority levels of the 3D objects based on the relevance of the search results to the input search word. The depths of the 3D objects may be determined based on their respective priority levels.

More specifically, referring to FIG. 12A, a user may input a search word into a search word input window 1031 by using a handwriting board, as shown in FIG. 10C, by using the remote control device 200 or a pointer device or by making a hand gesture.

The control unit 170 may display 3D objects 1032, 1033 and 1034 corresponding to search results obtained by performing search based on the search words A, B and C. More specifically, the control unit 170 may display the 3D objects 1032, 1033 and 1034 as if protruding toward the user.

The depths of the 3D objects 1032, 1033 and 1034 may be determined by the relevance of their respective search results to the input search word. The control unit 170 may assign a highest priority level to the 3D object 1032 corresponding to a search result that is 100% relevant to the input search word, a second highest priority level to the 3D object 1033 corresponding to a search result that is 80% relevant to the input search word, and a lowest priority level to the 3D object 1034 corresponding to a search result that is 50% relevant to the input search word.

Thereafter, the control unit 170 may perform image signal processing such that the 3D object 1032, 1033 and 1034 can have depths corresponding to their respective priority levels. In this exemplary embodiment, the control unit 170 may perform image signal processing such that a 3D object with a highest priority level, i.e., the 3D object 1032, can be displayed as if protruding the most toward the user.

Referring to FIG. 12B, a user may search through various content items present in the image display apparatus 100 or in an external device to which the image display apparatus 100 is connected by referencing the tags of the various content items. The term ‘tag,’ as used herein, means text information regarding a content item (for example, the time when the content item was last saved or edited or the file format of the content item).

The user may input search words A, B and C into a search word input window 1041. Then, the control unit 170 may display 3D objects 1042, 1043 and 1044 corresponding to search results obtained by performing search based on the search words A, B and C.

Thereafter, the control unit 170 may assign a priority level to each of the 3D objects 1042, 1043 and 1044 based on the relevance of a corresponding search result to the search words A, B and C. For example, the priority level of the 3D object 1042 corresponding to a search result that is relevant to all of the search words A, B and C may be higher than the priority level of the 3D object 1043 corresponding to a search result that is relevant to the search words A and B and the priority level of the 3D object 1044 corresponding to a search result that is relevant to the search word A.

The control unit 170 may perform image signal processing such that the 3D object 1042, 1043 and 1044 can have depths corresponding to their respective priority levels. In this exemplary embodiment, the control unit 170 may perform image signal processing such that a 3D object with a highest priority level, i.e., the 3D object 1042, can be displayed as if protruding the most toward the user.

According to the fifth exemplary embodiment, it is possible for a user to intuitively identify the relevance of a search result to a search word based on the depth of a 3D object corresponding to the search result.

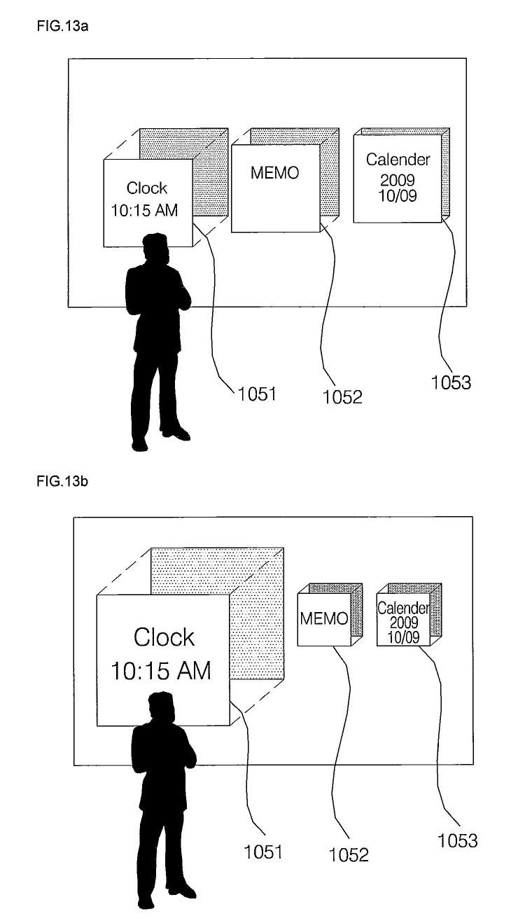

FIGS. 13A and 13B illustrate diagrams for explaining an operating method of an image display apparatus according to a sixth exemplary embodiment of the present invention. Referring to FIGS. 13A and 13B, a user may assign a higher priority level to a 3D object providing current time information than to other 3D objects. In this case, the control unit 170 may perform image signal processing such that the 3D object providing the current time information can be displayed as if protruding the most toward a user.

The priority level of a 3D object may be altered by a user. For example, a user may input a command to change the priority level of a 3D object to the image display apparatus 100 by making a hand gesture or using the remote control device 200 while viewing the 3D object. Then, the control unit 170 may change the depth of the 3D object by adjusting the parity between a left-eye image and a right-eye image generated by the formatter 320.

More specifically, referring to FIG. 13A, the image display apparatus 100 may display three 3D objects 1051, 1052 and 1053. The control unit 170 may determine the priority levels of the 3D objects 1051, 1052 and 1053, and may perform image signal processing such that the 3D objects 1051, 1052 and 1053 can have depths corresponding to their respective priority levels. The 3D object 1051 providing current time information may have a highest priority level, the 3D object 1052 allowing a user to input a memory may have a second highest priority level, and the 3D object 1053 providing current date information may have a lowest priority level.

The control unit 170 may perform image signal processing such that the 3D object 1051 can be displayed as if protruding the most toward the user, that the 3D object 1052 can be displayed as if protruding less than the 3D object 1051, and that the 3D object 1053 can be displayed as if protruding less than the 3D object 1052.

The priority levels of the 3D objects 1051, 1052 and 1053 may be determined by default setting. In this case, image signal processing may be performed such that a 3D object capable of allowing the user to input a command to the image display apparatus 100 can have a highest priority level and can thus be displayed as if located closer than other 3D objects to the user. For example, when the priority levels of the 3D objects 1051, 1052 and 1053 are yet to be determined by the user, the image display apparatus 100 may perform image signal processing such that the 3D object 1051 can be displayed as if located closer than the 3D objects 1052 and 1053 to the user.

Even after the priority levels of the 3D objects 1051, 1052 and 1053 are determined by default setting, the user may arbitrarily change the priority levels of the 3D objects 1051, 1052 and 1053. For example, even if the priority levels of the 3D objects 1051, 1052 and 1053 are determined by default setting such that the 3D object 1052 can displayed as if protruding more than the 3D objects 1051 and 1053 toward the user, the user may change the priority levels of the 3D objects 1051, 1052 and 1053 such that the 3D object 1051 can have a highest priority level. In this case, the control unit 170 may perform image signal processing such that the 3D object 1051 can have a greatest depth and can thus be displayed as if located closest to the user.

Referring to FIG. 13B, a user may set the priority level of a 3D object 1061 corresponding to a channel browser to be higher than the priority level of a 3D object 1062 corresponding to a game and the priority level of a 3D object 1063 capable of allowing the user to input a command to enter a setting menu.

In this case, the control unit 170 may identify the priority levels of the 3D objects 1061, 1062 and 1063, and may perform image signal processing such that the 3D object 1061 can be displayed as if protruding the most toward the user.

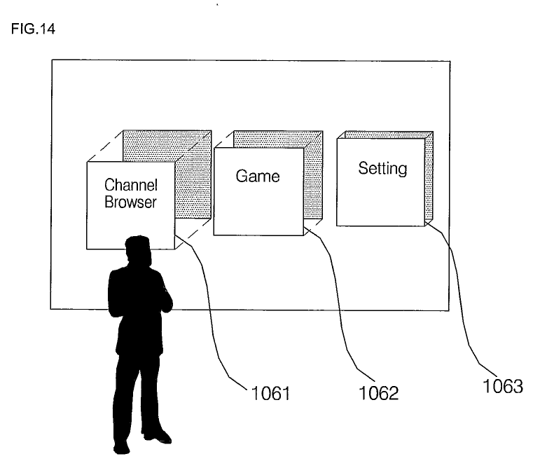

FIG. 14 illustrates a diagram for explaining an operating method of an image display apparatus according to a seventh exemplary embodiment of the present invention. In the seventh exemplary embodiment, the image display apparatus 100 may display a 3D object having a highest priority level so as to be larger in size than other 3D objects and appear as if located closest to a user.

Referring to FIG. 14, the image display apparatus 100 may display three 3D objects 1051, 1052, and 1053. The priority level of the 3D object 1051, which provides current time information, may be higher than the priority level of the 3D object 1052, which allows a user to input a memo, and the priority level of the 3D object 1053, which provides current date information. The priority levels of the 3D objects 1051, 1052 and 1053 may be determined by user or default setting.

The image display apparatus 100 may perform image signal processing such that the 3D object 1051 having the highest priority level can be displayed as being largest in size and can appear as if located closest to a user.

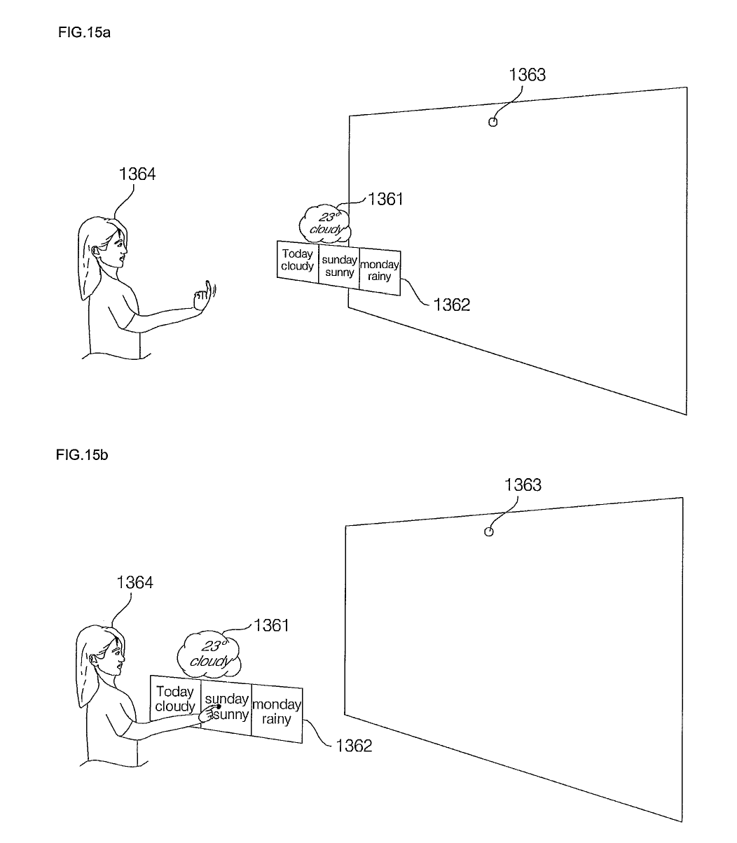

FIGS. 15A and 15B illustrate diagrams for explaining an operating method of an image display apparatus according to an eighth exemplary embodiment of the present invention. Referring to FIG. 15A, the image display apparatus 100 may determine the location of a user 1364 using a camera 1363, which is a type of motion sensor, and may display 3D objects 1361 and 1362 as if located in front of the user 1364 based on the results of the determination.

The user 1364 may input a command to change the depth of the 3D objects 1361 and 1362 to the image display apparatus 100 by making a hand gesture. Then, the image display apparatus 100 may capture an image of the hand gesture made by the user 1364 with the use of the camera 1363, and may identify the captured hand gesture as being a match for a command to bring the 3D objects 1361 and 1362 closer to the user 1364.

Thereafter, the image display apparatus 100 may perform image signal processing such that the 3D objects 1361 and 1362 can be displayed as if actually brought closer to the user 1364, as shown in FIG. 15B.

The user 1364 may input a 3D object-related command to the image display apparatus 100 by making a hand gesture. The image display apparatus 100 may detect the hand gesture made by the user with the aid of the sensor unit or a sensor attached onto the body of the user 1364. The user 1364 may also input a 3D object-related command to the image display apparatus 100 by using the remote control device 200.

The image display apparatus according to the present invention and the operating method of the image display apparatus according to the present invention are not restricted to the exemplary embodiments set forth herein. Therefore, variations and combinations of the exemplary embodiments set forth herein may fall within the scope of the present invention.

The present invention can be realized as code that can be read by a processor (such as a mobile station modem (MSM)) included in a mobile terminal and that can be written on a computer-readable recording medium. The computer-readable recording medium may be any type of recording device in which data is stored in a computer-readable manner Examples of the computer-readable recording medium include a ROM, a RAM, a CD-ROM, a magnetic tape, a floppy disc, an optical data storage. The computer-readable recording medium can be distributed over a plurality of computer systems connected to a network so that computer-readable code is written thereto and executed therefrom in a decentralized manner Functional programs, code, and code segments needed for realizing the present invention can be easily construed by one of ordinary skill in the art.

As described above, according to the present invention, it is possible to display an image to which a stereoscopic effect is applied so as to create the illusion of depth and distance. In addition, according to the present invention, it is possible to determine the priority level of a 3D object and change the depth of the 3D object in accordance with the determined priority level. Moreover, according to the present invention, it is possible to change the degree to which a 3D object appears protruding toward a user. Furthermore, according to the present invention, it is possible to change the depth of a 3D object in response a hand gesture made by a user and to allow the user to easily control an image display apparatus with a simple hand gesture.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of displaying three-dimensional (3D) objects by an image display device, the method comprising:
processing an image signal so as to determine a depth of a first 3D object; and
displaying the first 3D object at the determined depth,
wherein the depth of the first 3D object corresponds to one of an attribute of a file associated with the first 3D object and a user-selected priority level of the first 3D object.

2. The method of claim 1,
wherein the depth of the first 3D object corresponds to the user-selected priority level of the first 3D object, and
wherein the user-selected priority level is one of a user-selected file attribute priority level, a user-selected call priority level, and a user-selected channel selection priority level.

3. The method of claim 1,
wherein the depth of the first 3D object corresponds to the attribute of the file associated with the first 3D object, and
wherein the attribute of the file associated with the first 3D object is one of a file creation date, a file modification date, a file save date, a file alpha-numeric list order, and a file search parameter.

4. The method of claim 1,
wherein the depth of the first 3D object corresponds to the attribute of the file associated with the first 3D object, and
wherein the attribute of the file associated with the first 3D object is a file content tag.

5. The method of claim 1,
wherein the depth of the first 3D object corresponds to the attribute of the file associated with the first 3D object, the method further comprising:
determining the attribute of the file based on a user's selection of one of plural predetermined file attributes.

6. The method of claim 1,
wherein the depth of the first 3D object corresponds to the user-selected priority level of the first 3D object, and
wherein the step of processing comprises:
determining the user-selected priority level of the first 3D object based on stored data or based on a user input received during the step of processing; and
determining the depth of the first 3D object based on the determined priority level.

7. The method of claim 1, further comprising:
receiving a command to change the depth of the first 3D object;
reprocessing the image signal in response to the received command so as to change the depth of the first 3D object; and
displaying the first 3D object based on the reprocessed image signal.

8. The method of claim 1, further comprising:
receiving a signal for determining a location of a reference point; and
determining the location of the reference point based on the received signal,
wherein the step of displaying the first 3D object at the determined depth based on the processed image signal comprises displaying the first 3D object with reference to the determined reference point.

9. The method of claim 1, further comprising:
processing a second image signal so as to determine a depth of a second 3D object; and
displaying the second 3D object at the determined depth of the second 3D object while displaying the first 3D object,
wherein the depth of the second 3D object corresponds to one of an attribute of a file associated with the second 3D object and a user-selected priority level of the second 3D object.

10. The method of claim 9,
wherein the depth of the first 3D object and the depth of the second 3D object respectively correspond to the user-selected priority level of the first 3D object and the user-selected priority level of the second 3D object, and
wherein the step of displaying the second 3D object while displaying the first 3D object comprises one of:
displaying the first 3D object larger than the second 3D object when the user-selected priority level of the first 3D object is greater than the user-selected priority level of the second 3D object; and
displaying the first 3D object farther from the image display device than the second 3D object when the user-selected priority level of the first 3D object is greater than the user-selected priority level of the second 3D object.

11. The method of claim 9,
wherein the depth of the first 3D object and the depth of the second 3D object respectively correspond to the attribute of the file associated with the first 3D object and the attribute of the file associated with the second 3D object, and
wherein the step of displaying the second 3D object while displaying the first 3D object comprises one of:
displaying the first 3D object larger than the second 3D object when the attribute of the file associated with the first 3D object is prioritized higher than the attribute of the file associated with the second 3D object; and
displaying the first 3D object farther from the image display device than the attribute of the file associated with the first 3D object is prioritized higher than the attribute of the file associated with the second 3D object.

12. The method of claim 1, further comprising:
receiving a signal corresponding to a user gesture;
determining whether the user gesture matches a predetermined user gesture; and
if the user gesture matches the predetermined user gesture, varying a 3D display attribute corresponding to the predetermined user gesture.

13. An image display device configured to display three-dimensional (3D) objects, comprising:
a control unit configured to process an image signal so as to determine a depth of a first 3D object; and
a display configured to display the first 3D object at the determined depth,
wherein the depth of the first 3D object corresponds to one of an attribute of a file associated with the first 3D object and a user-selected priority level of the first 3D object.

14. The image display device of claim 13,
wherein the depth of the first 3D object corresponds to the user-selected priority level of the first 3D object, and
wherein the user-selected priority level is one of a user-selected file attribute priority level, a user-selected call priority level, and a user-selected channel selection priority level.

15. The image display device of claim 13,
wherein the depth of the first 3D object corresponds to the attribute of the file associated with the first 3D object, and
wherein the attribute of the file associated with the first 3D object is one of a file creation date, a file modification date, a file save date, a file alpha-numeric list order, and a file search parameter.

16. The image display device of claim 13,
wherein the depth of the first 3D object corresponds to the attribute of the file associated with the first 3D object, and
wherein the attribute of the file associated with the first 3D object is a file content tag.

17. The image display device of claim 13,
wherein the depth of the first 3D object corresponds to the attribute of the file associated with the first 3D object, and
wherein the control unit is configured to determine the attribute of the file based on a user's selection of one of plural predetermined file attributes.

18. The image display device of claim 13,
wherein the depth of the first 3D object corresponds to the user-selected priority level of the first 3D object, and
wherein the control unit is configured to:
determine the user-selected priority level of the first 3D object based on stored data or based on a user input received during the step of processing, or
determine the depth of the first 3D object based on the determined priority level.

19. The image display device of claim 13, further comprising:
a receiver configured to receive a command to change the depth of the first 3D object,
wherein the control unit is configured to reprocess the image signal in response to the received command so as to change the depth of the first 3D object, and
wherein the display is configured to display the first 3D object based on the reprocessed image signal.

20. The image display device of claim 13, further comprising:
a receiver configured to receive a signal for determining a location of a reference point,
wherein the control is configured to determine the location of the reference point based on the received signal, and
wherein the display unit is configured to display the first 3D object at the determined depth based on the processed image signal comprises displaying the first 3D object with reference to the determined reference point.

21. The image display device of claim 13,
wherein the control unit is configured to process a second image signal so as to determine a depth of a second 3D object,
wherein the display is configured to display the second 3D object at the determined depth of the second 3D object while displaying the first 3D object, and
wherein the depth of the second 3D object corresponds to one of an attribute of a file associated with the second 3D object and a user-selected priority level of the second 3D object.

22. The image display device of claim 21,
wherein the depth of the first 3D object and the depth of the second 3D object respectively correspond to the user-selected priority level of the first 3D object and the user-selected priority level of the second 3D object, and
wherein the display is configured to
display the first 3D object larger than the second 3D object when the user-selected priority level of the first 3D object is greater than the user-selected priority level of the second 3D object, or
display the first 3D object farther from the image display device than the second 3D object when the user-selected priority level of the first 3D object is greater than the user-selected priority level of the second 3D object.

23. The image display device of claim 21,
wherein the depth of the first 3D object and the depth of the second 3D object respectively correspond to the attribute of the file associated with the first 3D object and the attribute of the file associated with the second 3D object,
wherein the display is configured to
display the first 3D object larger than the second 3D object when the attribute of the file associated with the first 3D object is prioritized higher than the attribute of the file associated with the second 3D object, or
display the first 3D object farther from the image display device than the attribute of the file associated with the first 3D object is prioritized higher than the attribute of the file associated with the second 3D object.

24. The image display device of claim 13, further comprising:
a receiver configured to receive a signal corresponding to a user gesture,
wherein the control unit is configured to
determine whether the user gesture matches a predetermined user gesture, and
if the user gesture matches the predetermined user gesture, vary a 3D display attribute corresponding to the predetermined user gesture.
